(19) United States
(12) Patent Application Publication
(10) Pub. No.: US 2004/0184617 A1
(43) Pub. Date: Sep. 23, 2004

(54) Information apparatus, system for controlling acoustic equipment and method of controlling acoustic equipment

(75) Inventor: Tatsuya Ono, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/766,395

(22) Filed: Jan. 27, 2004

(30) Foreign Application Priority Data
Jan. 31, 2003 (JP) P2003-24851

(51) Int. Cl. H04R 29/00

(52) U.S. Cl. 381/59; 381/58

(57) ABSTRACT

An information apparatus controls a plurality of acoustic devices, each having at least one speaker unit. The apparatus has a memory storing first information corresponding to a number of speaker units of the corresponding acoustic device and the positions of their arrangement and a control unit configured to obtain second information corresponding to a position of a user and a number of channels to be used for reproducing a sound. The apparatus determines a combination of acoustic devices to be used for reproducing the sound by using the first and second information.

### CROSS-REFERENCE TO RELATED APPLICATIONS

This application is based upon and claims the benefit of priority from the prior Japanese Patent Application No. 2003-024851, filed Jan. 31, 2003, the entire contents of which are incorporated herein by reference.

### FIELD OF THE INVENTION

The present invention relates to an information apparatus, a system for controlling an acoustic equipment and method of controlling acoustic equipment, and particularly to an information apparatus which controls an acoustic equipment having a speaker unit.

### DESCRIPTION OF THE RELATED ART

In recent years, an increasing number of households have been furnished with an acoustic system adapted to a multiplicity of channels. When such an acoustic system is built up, in general, a plurality of speaker units are connected through wires or in a wireless manner with a central multi-channel-adapted amplifier and equipment corresponding thereto.

When the acoustic system corresponds to, for example, 5.1 channels, the plurality of speaker units (or speakers) include a center speaker, two front speakers (right/left 2 channels), two rear speakers (right/left 2 channels) and a sub-woofer (0.1 channel), which are disposed at predetermined positions in a room.

To obtain a sufficient degree of acoustic effect based upon a multiplicity of channels, a user stays in a limited area in the room and faces in a predetermined direction to enjoy music and images.

Japanese Patent Publication (Kokai) No. 2001-177890 discloses a system with which a user is allowed to enjoy music and images without having to stay in a small area, though this acoustic system has not been adapted to a multiplicity of channels. According to this literature, a wireless speaker connected to the home server is selected accompanying the motion of a wireless terminal carried by the user.

To obtain a sufficient multi-channel acoustic effect, the user must stay in a limited area in a room and must face a predetermined direction. As a result, the behavior of the user is inconveniently restricted.

### SUMMARY OF THE INVENTION

Accordingly, an advantage of the present invention is to provide an information apparatus which controls an acoustic equipment capable of obtaining an acoustic effect based on a multiplicity of channels without restraining the behavior of the user.

To achieve the above advantage, one aspect of the present invention is to provide an information apparatus capable of controlling a plurality of acoustic equipments having speaker units, and having a memory configured to store first information corresponding to a number of speaker units of the corresponding acoustic equipments and positions of their arrangement; and a control unit configured to obtain second information corresponding to a position of a user and a number of channels used for reproducing a sound, and to determine a combination of acoustic equipment used for reproducing the sound by using the first and second information.

### BRIEF DESCRIPTION OF THE DRAWING

FIG. 1 is a block diagram illustrating the whole constitution of an acoustic system for controlling acoustic equipment according to an embodiment of the invention.

FIG. 2 is a block diagram illustrating an internal constitution (hardware constitution) of a home server shown in FIG. 1.

FIG. 3 is a block diagram illustrating a functional constitution of a control unit shown in FIG. 2.

FIG. 4 is a diagram illustrating a management table related to the individual acoustic equipment stored in a memory shown in FIG. 2.

FIG. 5 is a block diagram illustrating an internal constitution (hardware constitution) common to the acoustic equipment shown in FIG. 1.

FIG. 6 is a diagram showing a screen for setting various kinds of information.

FIG. 7 is a diagram showing a screen for selecting a combination of acoustic equipment that are to be used.

FIG. 8 is a flowchart illustrating the operation of the home server shown in FIG. 1.

FIG. 9 is a flowchart concretely illustrating a processing at step A8 in FIG. 8.

### DETAILED DESCRIPTION OF THE INVENTION

An embodiment of the invention will now be described with reference to the drawings.

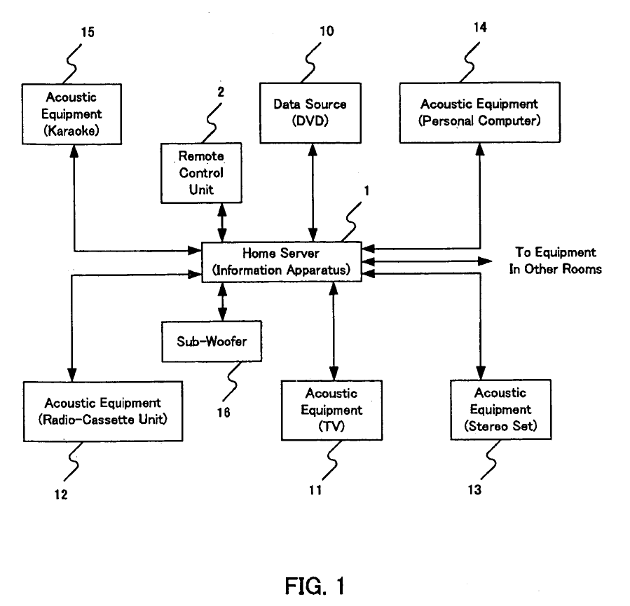

FIG. 1 is a block diagram illustrating the whole constitution of an acoustic system according to an embodiment of the invention.

The acoustic system illustrated in FIG. 1 is constituted by a home server (information apparatus) 1, a remote control unit 2, a data source 10, various acoustic equipment 11 to 16, which are arranged at predetermined positions in a room in a house, and acoustic equipment (not shown) arranged at predetermined positions in other rooms. The data source 10, acoustic equipment 11 to 16, and acoustic equipment in other rooms, are connected to the home server 1 through a wired or wireless network (e.g., wired LAN (local area network), a wireless LAN, a network in compliance with IEEE 1394 or a network in compliance with Bluetooth™. Further, each acoustic equipment has one or a plurality of speakers for producing sound (or voice). In this embodiment, the acoustic effect based on the multiplicity of channels is obtained by utilizing the speakers possessed by the aforementioned acoustic equipment. Here, several acoustic equipment units may be replaced by speaker units.

The position and arrangement of the acoustic equipment can be changed or the acoustic equipment can be separated away from the home server. It is further allowable to add new acoustic equipment to the acoustic system.

The home server 1 is an information equipment capable of offering, to information equipment through the network, services related to viewing and recording program data such as of TV broadcast as well as services related to connecting to the internet. In particular, the home server 1 according to this embodiment stores, in a storage medium, information related to the individual acoustic equipment connected to the network as well as information related to the position of the user, data source and the number of the channels used for reproducing the audio The home server 1 determines a suitable combination of acoustic equipment (inclusive of a combination of speakers) used for reproducing the audio based upon the above information, and reproduces the audio by using the speakers of the determined acoustic equipment.

The remote control unit 2 includes various buttons for input operation and is used for issuing various instructions to the home server 1 in a wireless manner. The main body of the home server 1, too, is provided with the same buttons as the buttons of the remote control unit 2 so that the same functions provided on the remote control unit 2 may also be implemented directly on the home server 1.

The data source 10 is, for example, a DVD (digital versatile disk) drive which drives a DVD storing audio/video data (contents), and is capable of transmitting the data to the home server 1. The data source 10 is one of several data sources that are to be reproduced by the acoustic system of the invention.

The acoustic equipment 11 may, for example, be a TV which has a display device for displaying images and three speakers (center speaker, left speaker and right speaker: 3 channels) for producing audio.

The acoustic equipment 12 may, for example, be a radio-cassette unit having two speakers (left speaker and right speaker: 2 channels).

The acoustic equipment 13 may, for example, be a piece of stereo equipment having two speakers (left speaker and right speaker: 2 channels).

The acoustic equipment 14 may, for example, be a personal computer having two speakers (left speaker and right speaker: 2 channels).

The acoustic equipment 15 may, for example, be karaoke equipment having one speaker (1 channel).

The sub-woofer 16 may be an acoustic equipment for producing low-pitched sound and has one speaker (0.1 channel).

In general, audio equipment represented by any one of units 10-15 may serve as input data sources to the home server 1 and the home server 1 is operable to direct the audio (and/or video) received therefrom to any one or more of the speakers associated with the input data source or the other units 10-15.

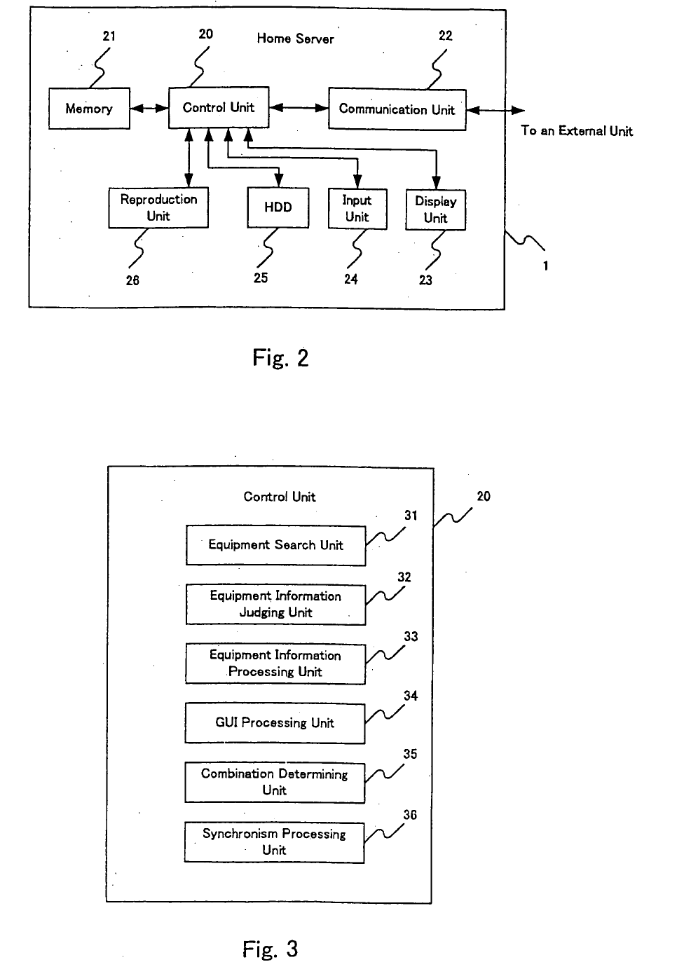

FIG. 2 is a block diagram illustrating the internal constitution (hardware constitution) of the home server 1 shown in FIG. 1.

The home server 1 includes a control unit 20, a memory 21, a communication unit 22, a display unit 23, an input unit 24, an HDD (hard disk drive) 25 and a reproduction unit 26.

The control unit 20 controls the operation of the entire home server 1, writes/reads information into and from the memory 21, receives/transmits information from and to the network through the communication unit 22, displays information on the display unit 23 (and/or on a display unit of a personal computer connected to the home server 1), receives information from the input unit 24 (and/or from the input unit of a personal computer connected to the home server 1), controls the HDD 25 and the reproduction unit 26, measures response delay times obtained by transmitting signals to the individual acoustic equipment, executes various kinds of decision making, and maintains synchronism among the plurality of acoustic equipment. The control unit 20 further turns on/off the power sources of equipment connected to the network.

The memory 21 stores a management table which includes data corresponding to equipment IDs (e.g., MAC address when the network is LAN), kind of equipment, number of speakers, speaker IDs, positions of the arrangement of the speakers, number of channels and delay times for each of the acoustic equipment as information related to the individual acoustic equipment, and further stores the position of the user specified through the screen, data source and the number of channels used for reproducing the audio/video data.

The communication unit 22 connects/disconnects the network to and from each of the individual acoustic equipment, and receives/transmits information (audio/visual content data) from and to each acoustic equipment connected through the network.

The display unit 23 displays a screen for registering acoustic equipment, a screen for setting a variety of kinds of information, and a screen for selecting a combination of acoustic equipment that are to be used. These screens may be provided on the single display unit 23 and may be presented at different times depending on the functions desired to be performed or displayed.

The input unit 24 transmits information related to the input operation by the user (inclusive of the input of data by using the remote control unit 2) to the control unit 20.

The HDD 25 drives the hard disk storing the data such as voice, music, images and the like (i.e., audio/video data).

Depending upon the input operation by the user, the reproduction unit 26 executes the reproduction of data such as voice, music and images stored in the hard disk in the HDD 25, quick feed, review, pause and stop.

FIG. 3 is a block diagram illustrating the functional constitution of the control unit 20 shown in FIG. 2.

The control unit 20 includes an equipment retrieval unit 31, an equipment information judging unit 32, an equipment information processing unit 33, a GUI (graphical user interface) processing unit 34, a combination determining unit 35 and a synchronism processing unit 36.

The equipment retrieval unit 31 retrieves (or searches) the individual acoustic equipment connected to the network and obtains equipment IDs for specifying the acoustic equipment.

The equipment information judging unit 32 judges whether the information related to the equipment IDs of acoustic equipment obtained by the equipment information retrieval unit 31 has already been stored in the memory 21.

When information has not been stored in the memory 21 as judged by the equipment information judging unit 32, the equipment information processing unit 33 obtains equipment IDs of the corresponding acoustic equipment, types thereof, number of speakers, speaker IDs, positions and arrangement of the speakers and the number of channels, and stores such data in the memory 21. The equipment information processing unit 33 measures the delay times of response obtained by sending predetermined signals to the individual acoustic equipment (during an initialization or set-up procedure)and stores these delay times in the memory 21.

The GUI processing unit 34 displays, on the display unit 23, a screen for registering acoustic equipment, a screen for setting various kinds of information (position of the user, positions of acoustic equipment, data source, number of channels used for reproducing the audio and/or video data, etc.), and a screen for selecting a combination of acoustic equipment to be used, and, further, executes a processing for storing, in the memory 21, the contents input by the user through the screens.

The combination determining unit 35 determines a combination of acoustic equipment (inclusive of a combination of speakers) used for the reproduction of audio/video according to a predetermined rule or algorithm by using various kinds of data stored in the memory 21. At this moment, for example, predetermined acoustic equipment are preferentially selected, or the corresponding speakers are selected in a specified number of channels successively starting with the acoustic equipment closest to the position of the user. The rules used for selecting the equipment may be changed depending upon whether the data source has data related to images or is only audio. Then, the thus determined combination of acoustic equipment (inclusive of the combination of speakers) is displayed on the display unit 23 through the GUI processing unit 34. When there are obtained a plurality of candidates of combinations of acoustic equipment, a screen may be displayed to show the plurality of candidates so that any one of them can be selected by the user. Alternatively, a candidate may be determined by default according to a predetermined rule.

The synchronism processing unit 36 transmits the audio/video data reproduced by the reproduction unit 26 to acoustic equipment having corresponding speakers while maintaining synchronism among the acoustic equipment that are used for reproducing the audio by using delay times stored in the memory 21. The synchronism processing unit 36, at the same time, transmits the data of images, if there exists any, to the corresponding display unit.

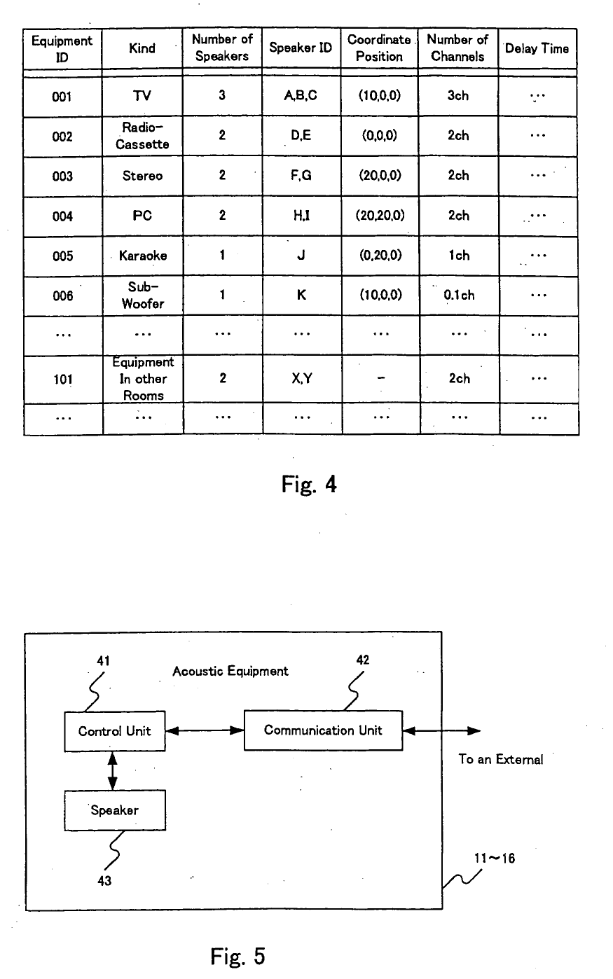

FIG. 4 is a diagram illustrating a management table related to the individual acoustic equipment stored in the memory 21 shown in FIG. 2.

The management table stores various kinds of information for each of the acoustic equipment. In an example of FIG. 4, acoustic equipment arranged in a room are a TV, a radio-cassette unit, a stereo unit, a personal computer, a karaoke unit and a sub-woofer which correspond to equipment IDs “001” to “006”. There is further illustrated acoustic equipment of equipment ID “101” located in another room.

In the above management table are further described the number of speakers, speaker IDs and a maximum number of channels that can be used in addition to equipment IDs of various acoustic equipment and the kinds of equipment. There are further described the positions of the acoustic equipment which may be described as coordinate positions (a two-dimensional plane is expressed using coordinates X and Y, and the height is expressed by the Z coordinate). As an example, the center of the coordinate system may be conveniently chosen to be a corner of a room, and the X and Y coordinates may take on the representative values 0, 10 or 20. Further, Z expressing the height may be measured reative to the floor as zero so that all values will be positive. The Z coordinate may thus assume values of 0, 10 or 20 representing lower, middle and high. In the management table there is also provided a column for storing delay times of response obtained by transmitting signals to the acoustic equipment.

Information on the management table is used for determining a combination of acoustic equipment (inclusive of a combination of speakers) that are to be used. Further, information on the management table is displayed on the screen for registration at the time when the user newly registers the acoustic equipment.

FIG. 5 is a block diagram illustrating the internal constitution (hardware constitution) which is common to the acoustic equipment 11 to 16 shown in FIG. 1.

The acoustic equipment 11 to 16 include at least a control unit 41, a communication unit 42 and a speaker 43. In some cases, as for example, the TV 11 of FIG. 1, there is further provided video processing and display apparatus (not shown).

The control unit 41 controls the operation of the entire acoustic equipment, receives/transmits information from and to the network through the communication unit 42, and sends the audio data received from the communication unit 42 to the speaker 43.

The communication unit 42 connects/disconnects the network to and from the home server 1, and receives/transmits information from and to the home server 1 connected through the network.

The speaker 43 produces, as sound waves, the audio data sent from the control unit 41.

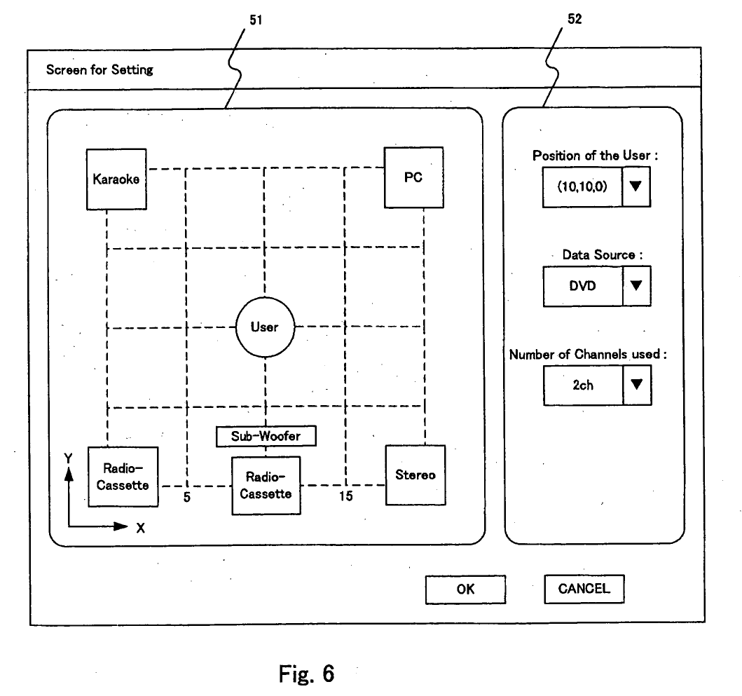

FIG. 6 is a diagram illustrating a screen for setting various kinds of information.

The screen shown in FIG. 6 is displayed by the GUI processing unit 34 in the control unit 20 shown in FIG. 3. This screen includes a first display region 51 and a second display region 52.

The first display region 51 is a graphic display region showing the positions where the individual acoustic equipment are arranged in a room and a relationship of positions thereof on a two-dimensional plane defined by coordinate axes X and Y based on the contents of the management table shown in FIG. 4. The display of the first region 51 can be changed over to a display of positions where the acoustic equipment are arranged in other rooms. By using an input device, the user specifies the position where he is staying in the first display region 51. Information related to the positions can also be reflected, as information representing coordinates, in displaying the position of the user in the second display region 52.

The second display region 52 includes items for specifying the position of the user, data source and the number of channels to be used. In the second display region 52, the position of the user can be specified in the form of coordinates. As the data source, there can be specified equipment and storage medium connected to the home server 1, as well as the HDD which is contained in the home server 1. The number of channels to be used can be freely specified over a range of, for example 1 channel to 5.1 channels. The items may display the contents that are recommended to be defaults.

It is to be noted that the user may store a plurality of positions each associated with the same or different source data and with different numbers of channels. For each such “user setting” the position of the user is specified as well as the source of the audio/visual data and the number of channels. Plural user settings may be stored in the memory 21 at the same time and thus easily selected by the user by simply choosing the user setting desired from a stored list of user settings stored in the memory 21. For example, one user setting stored in memory 21 may be the data source for the karaoke equipment 15 using only one channel which is typically, but not necessarily, the speaker built into the karaoke machine itself. However, the user may want to listen to the karaoke machine as a data source, but listen to it using 3 channels. Such an operation may be desirable when the user is having a large party and wants many speakers to carry the audio content for all to hear in one or plural rooms. In such a case, the user will specify the karaoke equipment as the data source and also specify 3 channels. Under these conditions, one channel may be selected corresponding to the speaker within the karaoke equipment itself, and the other two channels may be obtained by using the stereo equipment 13. In this way, the audio data input from the karaoke equipment into the home server is then output to the stereo set 13 as well as to the karaoke equipment to provide the desired 3 channels. It is noted that it is not necessary to use the speaker of the karaoke machine itself and the user could, for example, choose to only use the two channels from the stereo device to reproduce the content audio data from the karaoke machine.

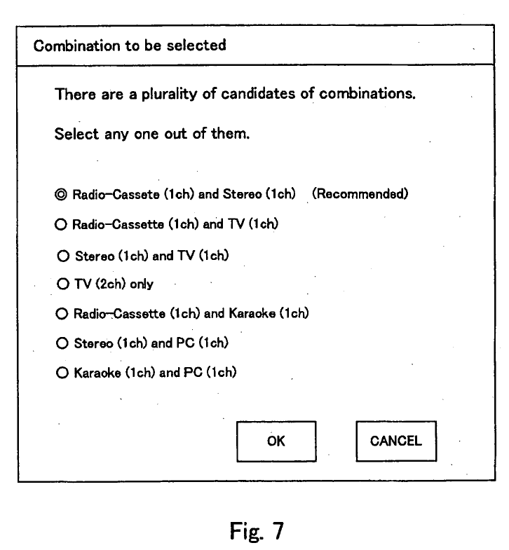

In the above example, there may be a plurality of possible choices to achieve the desired three channels for the karaoke equipment. While one channel will almost always be supplied by the karaoke equipment itself, the other two channels may be supplied by the stereo equipment 13 as discussed above or alternatively by the radio cassette, the PC or equipment in other rooms. The above choices are taken from the two channel options set forth in FIG. 4. However, FIG. 4 is understood to be merely an example and alternate arrangements will be readily apparent to those skilled in the art. When plural possible speaker options are possible combination candidates are presented as shown in FIG. 7 explained below. The user position input in the second display region of Fib. 6 and forming part ot the “user settings” may here be used to select or recommend one of the combinations as shown in FIG. 7 (“Recommended”). Thus, if the user position is near the stereo, the stereo would be recommended to provide two of the desired three channels. Thus user, of course may choose other than the recommended combination.

When the user depresses an OK button on the screen, various kinds of specified information are stored in the memory 21 through the GUI processing unit 34 to execute a processing for determining a combination of acoustic equipment (inclusive of a combination of the speakers) used for reproducing the audio. Therefore, the acoustic equipment determined to be used for the reproduction of audio are displayed, for example, on the first display region 51 being distinguished over other acoustic equipment by color or density. There may be further displayed a combination of the speakers that are to be used.

The first display region 51 (and also the second display region 52) may be implement with a touch screen display for ease of data input. In this case, a room may be graphically displayed and the user may input the dimensions of each length of the room using, for example an on-screen keyboard on entry screen. Gradations may be automatically displayed overlaying the room to permit the user to estimate distances. The position of say the radio cassette may be represented on the screen using an icon and the icon may be selected and dragged to a new position on the screen representing the new position that the user choose dot place the audio equipment. The input coordinates will then be automatically known from the new position of the icon and the user need not enter the actual values of the X, Y coordinates. Similarly other equipment may be easily selected and dragged to its appropriate relative position on the display. The input data for the user position may likewise be made by selecting the user icon and dragging it to a new position. After selecting the positions of the audio/visual equipment, user positions, and after selecting the number of channels as well as the source data, the user saves the selected information in the memory 21 under a suitable name so that it may be easily retrieved if desired by the user.

It is further noted that while the positional data which is shown store in FIG. 4 relates to the coordinate position of the equipment (i.e., Stereo, PC, karaoke device), it is clear that the coordinate positional information may be more specific and designate the position of each speaker within a piece of audio equipment. Thus, for stereo equipment 13. for example, the position of each speaker of the stereo device may be separately input as data and the time delays measured with respect to each speaker. In this manner a more sophisticated program for selecting an appropriate combination of speakers dependent on the user position and the number of desired channels may be made. Moreover, even in the case of a piece of audio equipment having only one speaker, such as a karaoke machine, it may be desirable to input the position of the speaker within the device as opposed to the position of the device itself although in most cases this data will be almost the same. There may be a difference only in certain cases where the speaker is off to one side or near the bottom of a piece of audio equipment. Inputting the position of the speaker as opposed to the position of the audio equipment itself will result in greater accuracy as to the positional information.

FIG. 7 is a diagram showing a screen for selecting a combination of the acoustic equipment to be used.

When there are a plurality of candidates for acoustic equipment to be used for the reproduction of audio in as judged by the combination determining unit 35 in the control unit 20 shown in FIG. 3, the screen shown in FIG. 7 is displayed through the GUI processing unit 34. The most recommended one is displayed at the highest position. The user is allowed to select a desired candidate on the screen.

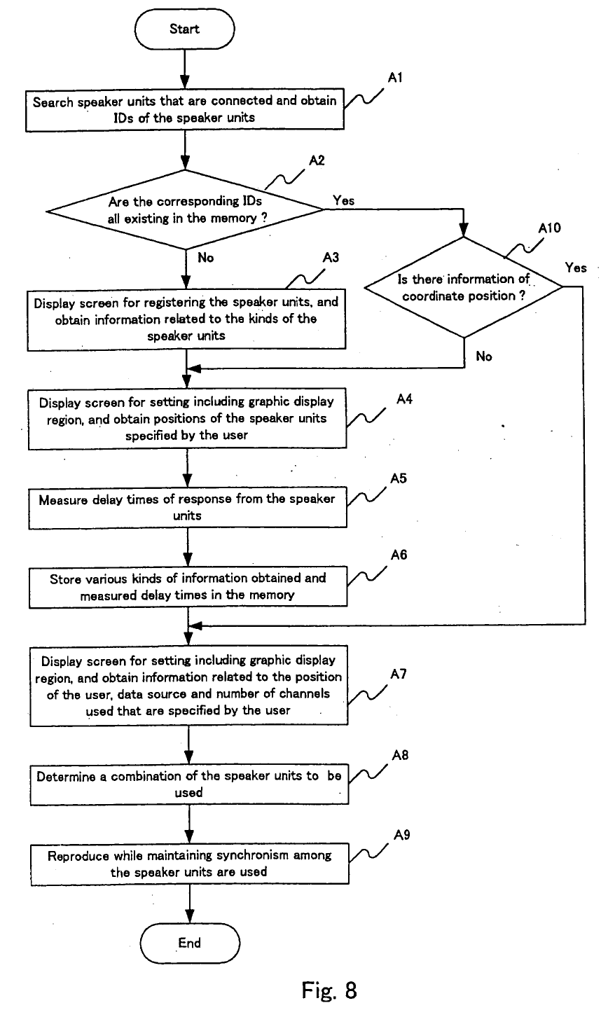

Next, the operation of the home server 1 will be described with reference to a flowchart of FIG. 8.

The home server 1 retrieves acoustic equipment (i.e., speaker units) connected through the network and obtains equipment IDs from the corresponding acoustic equipment (step A1).

Here, it is judged whether the corresponding equipment IDs are all already present in the management table in the memory 21 (step A2).

If there is any equipment ID that has not been stored in the management table in the memory 21 as judged above (no at step A2), the screen of the management table is displayed for registering the corresponding acoustic equipment enabling the user to input data related to the kind and the number of channels. If there is information that can be automatically obtained from the corresponding acoustic equipment, such information is obtained in advance and is reflected on the management table. Information input by the user is stored in the management table (step A3).

Next, a screen including a of a graphic display region is displayed enabling the user to specify the positions where acoustic equipment to be registered are arranged. Thus, there is obtained information (coordinates) related to the positions of arrangement specified by the user (step A4). Such a screen may take the form of the first display region shown in FIG. 6 for example. Next, a predetermined signal is sent to the acoustic equipment to be registered, and the delay times of response are obtained and measured (step A5).

Various kinds of information thus obtained and the delay times that are measured, are stored in the memory 21 (step A6).

When the corresponding equipment IDs are all existing in the management table in the memory 21 at step A2 (yes at step A2), it is judged whether there is information (coordinates) related to the positions where the corresponding acoustic equipment are arranged (step A10). If there is no information related to the positions of the speaker units, the routine proceeds to a processing of step A4, and processes A4-A6 are performed as previously described. If there is information related to the positions of arrangement, on the other hand, the routine proceeds to a processing of step A7.

A screen inclusive of a graphic display region is displaced enabling the user to input the user's position, data source and the number of channels to be used. The second display region of FIG. 6, is an example of this screen. Thus, there are obtained the position of the user, the data source and the number of channels to be used that are specified by the user (step A7). This information, too, is stored in the memory 21.

A processing is executed based on the thus obtained position of the user, the data source and the number of channels to be used to determine a combination of acoustic equipment (inclusive of a combination of the speakers) used for reproducing the audio data (step A8). In this case, reference is made to information (positions of arrangement, number of channels, etc.) on the management table to determine the combination according to a predetermined rule or algorithm. For example, predetermined acoustic equipment are preferentially selected, or the corresponding speakers are selected in a specified number of channels starting with the acoustic equipment closest to the position of the user. The thus determined combination of acoustic equipment (inclusive of the combination of speakers), is also stored in the memory 21.

The audio data are reproduced from the specified data source, and are sent to the corresponding speakers of the acoustic equipment while maintaining synchronism among the acoustic equipment by using the delay times stored in the memory 21 (step A9). If there exists any video (image), the data thereof are also transmitted to the corresponding display unit of the acoustic equipment (i.e. the display of TV unit 11 of FIG. 1).

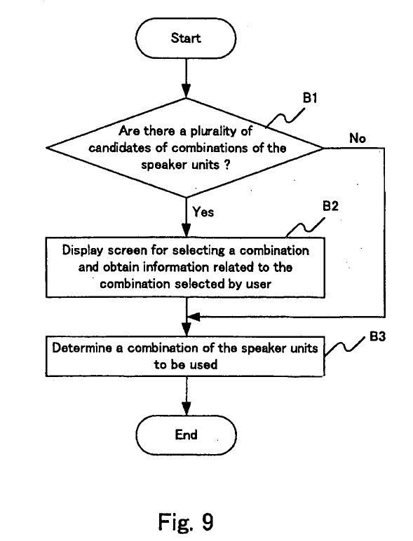

Next, described below with reference to FIG. 9 is a concrete processing at step A8 in FIG. 8.

In determining a combination of acoustic equipment (inclusive of a combination of speakers), it is fist judged whether there are a plurality of possible candidates combinations of speakers (step B1).

If there are a plurality of combination candidates, there is displayed a screen for selecting the possible combinations thus enabling the user to select any one out of the plurality of candidates. Thus, there is obtained information related to the combination selected by the user (step B2). When there is no plurality of combination candidates at step B1, on the other hand, the routine proceeds to a processing of step B3.

Finally, a combination of acoustic equipment to be used is determined (step B3).

According to this embodiment as described above, the user simply specifies the position of the user and the channel numbers on the screen to suitably determine a desired combination of acoustic equipment (inclusive of a combination of speakers) that are to be used for the reproduction of audio. Therefore, the user can easily realize a desired comfortable environment and can sufficiently enjoy acoustic effects based on the multiplicity of channels. Besides, since this embodiment utilizes speakers possessed by the existing acoustic equipment, there is no need to install new speakers. When there are a plurality of combination candidates of acoustic equipment, these candidates are displayed on the screen, and the user may select any one of them to easily realize a desired environment.

The invention is in no way limited to the above-mentioned embodiment, but can be modified in a variety of other ways without departing from the gist and scope of the invention.

What is claimed is:

1. A method of controlling a plurality of acoustic devices, each device having at least one speaker unit, comprising:
storing first information specifying the number of speaker units corresponding to each acoustic device and the position of at least one of (1) the corresponding acoustic device and (2) one or more speaker units of the corresponding acoustic device;
obtaining second information corresponding to a position of a user and a number of channels to be used for reproducing a sound; and
determining one or more acoustic devices from among said plurality of acoustic devices used for reproducing the sound by using the first and second information.

2. A method of controlling according to claim 1, wherein the position of the user is specified by the user on a display screen.

3. A method of controlling according to claim 1, wherein the number of channels used for reproducing the sound is specified by the user on a display screen.

4. A method of controlling according to claim 1, wherein a data source used for reproducing the sound is specified by the user on a display screen.

5. A method of controlling according to claim 1, further comprising the steps of:
displaying on a display screen having a graphic display region, the position of the plurality of acoustic devices and the position of the user.

6. A method of controlling according to claim 5, wherein the determining step determines at least two different groups of acoustic devices from among said plurality of acoustic devices, each group having at least two acoustic devices from among said plurality of acoustic devices and having a total channel equal to the number of channels specified in the second information, and
said displaying step displays said at least two different groups.

7. A method of controlling according to claim 5, further comprising specifying the positions of said plurality of acoustic devices or said speaker units within said acoustic devices using said graphic display region.

8. A method of controlling according to claim 1, further comprising the steps of:
transmitting signals to each of said plurality of acoustic devices;
measuring delay times of responses obtained when transmitting said signals to the plurality of acoustic devices; and
maintaining synchronism among the plurality of acoustic devices used for reproducing the sound by using the measured delay times.

9. A method of controlling according to claim 1, wherein the determining step includes:
determines at least two different groups of acoustic devices from among said plurality of acoustic devices, each group having at least two acoustic devices from among said plurality of acoustic devices and having a total channel equal to the number of channels specified in the second information;
displaying said at least two different groups as displayed results; and
selecting one of said groups by utilizing said displayed results.

10. An information apparatus capable of controlling a plurality of acoustic devices each having at least one speaker unit, comprising:
a memory configured to store first information corresponding to a number of speaker units of the corresponding acoustic device and a position of one of (1) the acoustic device, and (2) the at least one speaker unit of the corresponding acoustic device; and
a control unit configured to obtain second information corresponding to a position of a user and a number of channels to be used for reproducing a sound, and to determine a combination of at least two acoustic devices used for reproducing the sound by using the first and second information.

11. A system for controlling a plurality of acoustic devices, each having at least one speaker unit and information equipment capable of controlling the acoustic equipments, wherein the information equipment includes:
a memory configured to store first information corresponding to a number of speaker units of the corresponding acoustic devices and a position of one of (1) the positions of acoustic devices and (2) the positions of the speaker units of the corresponding acoustic device; and
a control unit configured to obtain second information corresponding to a position of a user and a number of channels to be used for reproducing a sound, and to determine a combination of acoustic devices used for reproducing the sound by using the first and second information.

12. A server for controlling a plurality of acoustic devices, each acoustic device having at least one speaker for reproducing audio data comprising:
a display unit;
an input device;
a communication unit connected to each of said plurality of acoustic devices by means of wire or wireless connection;
a memory for storing first and second information;
a control unit connected to said input unit, said communication unit and said memory for controlling same;
said server operative by said control unit in cooperation with said display unit to receive first and second information from said input unit and to store same in said memory;
said first information including to the number of speaker units corresponding to each acoustic device and the position of one of (1) the acoustic device and (2) the position of the one or more speaker units in said corresponding acoustic device;
said second information including a position of a user of said server and the number of channels to be used in reproducing sound by said acoustic devices.

13. A method of controlling a plurality of acoustic devices connected to a network, each acoustic device having at least one speaker unit, comprising:
searching for the acoustic devices which are connected to the network;
determining, for each acoustic device found in said searching step, whether first information corresponding to a number of speaker units of the corresponding acoustic devices and the positions of one of (1) the speaker units and (2) the acoustic devices, is stored in a memory;
obtaining the first information, when it is determined that the first information is not stored in said memory;
obtaining second information corresponding to a position of a user and a number of channels used for reproducing a sound; and
determining a combination of acoustic devices to be used for reproducing the sound by using the first and second information.
